(19) United States
(12) Patent Application Publication
(10) Pub. No.: US 2008/0284819 A1
(43) Pub. Date: Nov. 20, 2008

(54) LIQUID EJECTING HEAD AND LIQUID EJECTING APPARATUS

(75) Inventors: Hiroshige OWAKI, Okaya-shi (JP); Hiroki HONMA, Matsumoto-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 12/119,565

(22) Filed: May 13, 2008

(30) Foreign Application Priority Data
May 15, 2007 (JP) 2007-129867

(51) Int. Cl. B41J 2/135

(52) U.S. Cl. 347/44

(57) ABSTRACT

A liquid ejecting head comprising a head body capable of ejecting liquid in from pressure generating chamber through nozzles by driving the pressure generating chamber, a plurality of head members adhered to the head body, the head members comprising a head casing having a channel for supplying the liquid to the pressure generating chamber and a plurality of notches for allowing a first and second adhesive to be filled in a plurality of gaps between the head members adhered to the head body, and a fixed member which is adhered to the liquid ejecting surface of the head members, wherein the first and second adhesive have different viscosities.

### BACKGROUND

The entire disclosures of Japanese Patent Application No. 2007-129867, filed May 15, 2007 is expressly incorporated herein by reference.

1. Technical Field

The present invention relates to a liquid ejecting apparatus and a liquid ejecting head capable of ejecting liquid droplets from a plurality of nozzles. More particularly, the present invention relates to an ink jet recording head and an ink jet recording apparatus, which include a pressure generating chamber capable of communicating with the plurality of nozzles which is composed of a piezoelectric element on a vibration plate, wherein ink droplets are ejected from the nozzles by displacing the piezoelectric element provided on the vibration plate.

2. Related Art

One liquid ejecting head capable of ejecting liquid droplets from a plurality of nozzles using a piezoelectric element is an ink jet recording head capable of ejecting ink droplets. Typically, the ink jet recording heads include a plurality of head members, which include nozzle plates, in which nozzle openings are formed, and head casings attached to a channel forming substrate, in which a pressure generating chamber is formed. The plurality of head members are then adhered to a fixed member, such as a fixed plate and covered by the head casing. One example of such an ink jet recording head is described in Japanese Patent Application No. JP-A-2005-096419.

One problem with such configurations, however, is that ink may accumulate in the gaps between the plurality of head members. This ink may adhere to a recording medium during the printing processes, causing printing failures.

In order to solve this problem, a number of recording heads, such as the recording head disclosed in Japanese Patent Application No. JP-A-2006-62373, wherein the gaps between the plurality of head members is filled with an adhesive.

One problem with the adhesive filled recording heads, however, is that the fixed member comprising the nozzle surface may be curved by the adhesive contracting after the curing process, shrinking the space between the head members and causing the fixed to curve. Recently, the size of the ink jet recording head has been reduced, meaning that the fixed member even a slight contracting in the adhesive during the curing process may create a curve or change in shape of the fixed member, which may modify the direction that the ink droplets are ejected during a printing process, thus causing the printing quality to deteriorate.

In some instances, an adhesive with a relatively high viscosity is used between the gaps of the head members in order to suppress the curvature of the fixed member. One problem with this configuration, however, is that the gaps between the head members are narrow, making it difficult to adequately fill the space with an adhesive with a high viscosity. While such problems can be solved by increasing the gaps between the head members, this increases the size of the recording head. Another difficulty with this configuration is that in instances where the adhesive between the head members and the fixed member is used to adhere the head members to the fixed member, any failures in adequately filling the gaps with the adhesive may result in an adhesion failure between the head members and the fixed member may occur.

### BRIEF SUMMARY OF THE INVENTION

An advantage of some aspects of the invention is that it provides a liquid ejecting head and a liquid ejecting apparatus which are capable of fixing head members to a fixed member using an adhesive while reliably closing the gaps between adjacent head members.

One aspect of the invention is a liquid ejecting head comprising head body capable of ejecting a liquid in a pressure generating chamber through a plurality of nozzles from a liquid ejecting surface by pressurizing the pressure generating chamber, a plurality of head members having a liquid pressure generating chamber and a head casing with a channel capable of supplying the liquid to the pressure generating chamber, the head casing having a plurality of first and second notch portions, wherein the first notch portions extend through the head casing and to reach a lower surface of the head casing, while the second notch portions extend through a portion of the head casing without reaching the lower surface of the head casing, a fixed member adhered to a liquid ejecting surface of the head members on which the plurality of head members are positioned at predetermined intervals with a plurality of gaps being formed between the head members, and a filing portion filled in the plurality of gaps between the head members and cured, the filing portion comprising a predetermined adhesive including a first filling layer comprising a first adhesive provided on the fixed member and a second filling layer provided on the first filling layer which is comprised of a second adhesive having a viscosity higher than that of a first adhesive in an uncured state. In the ink recording head of the present invention, the first adhesive is introduced into the gap between the head members via the first notch portions of the head casing and the second adhesive is introduced into the gap between the head members via the second notch portions of the head casing.

In the invention, the fixed member and the head body are adequately fixed by the first filling layer comprised of a first adhesive, while the gaps between the head members are filled by the second filling layer comprised of a second adhesive having a viscosity higher than that of the first adhesive in the uncured state. Accordingly, deformation of the fixed member due to the shrinkage of the adhesive upon curing is suppressed.

Since the second notch portions are formed without reaching the lower surface of the head casing, the area in which the second notch portions are formed is easily accessible, meaning that there is no need to increase the size of the gaps between the head members, making it possible to miniaturize the size of the recording head.

### BRIEF DESCRIPTION OF THE DRAWINGS

The invention will be described with reference to the accompanying drawings, wherein like numbers reference like elements.

FIG. 1 is an exploded perspective view of a recording head according to a first embodiment of the invention;

FIG. 2 is an assembled perspective view of the recording head of the first embodiment of the invention;

FIG. 3 is a cross-sectional view of the main portions of the recording head of the first embodiment of the invention;

FIG. 4 is an exploded perspective view of a head member of the first embodiment of the invention;

FIG. 5 is a cross-sectional view of the head member according of the first embodiment of the invention;

FIG. 6 is a cross-sectional view of the main portions of the recording head according to of the first embodiment of the invention;

FIG. 7 is a plan view of a head casing according to of the first embodiment of the invention;

FIG. 8 is a cross-sectional view showing a process of forming a filling unit according to of the first embodiment of the invention; and

FIG. 9 is a schematic view of a recording apparatus according to an embodiment of the invention.

### DESCRIPTION OF EXEMPLARY EMBODIMENTS

Hereinafter, embodiments of the invention will be described in detail.

### Embodiment 1

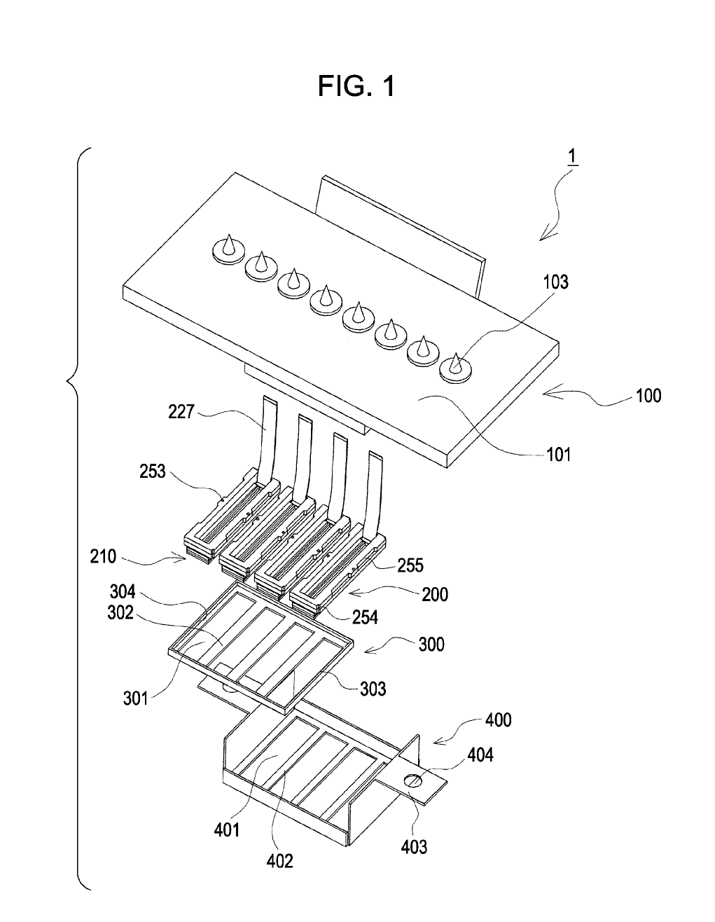

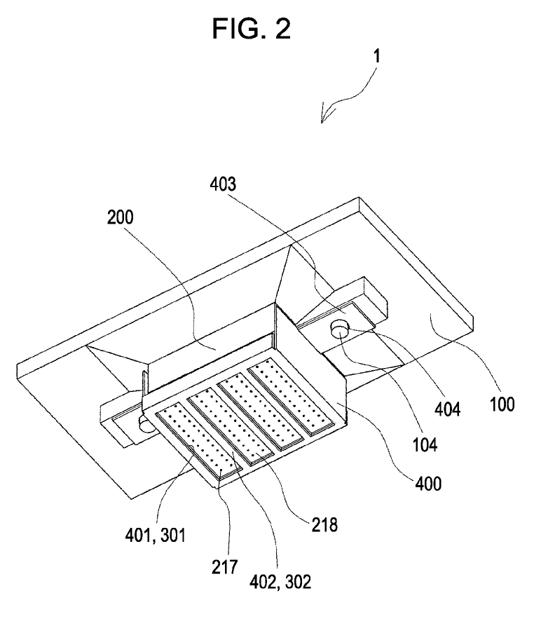

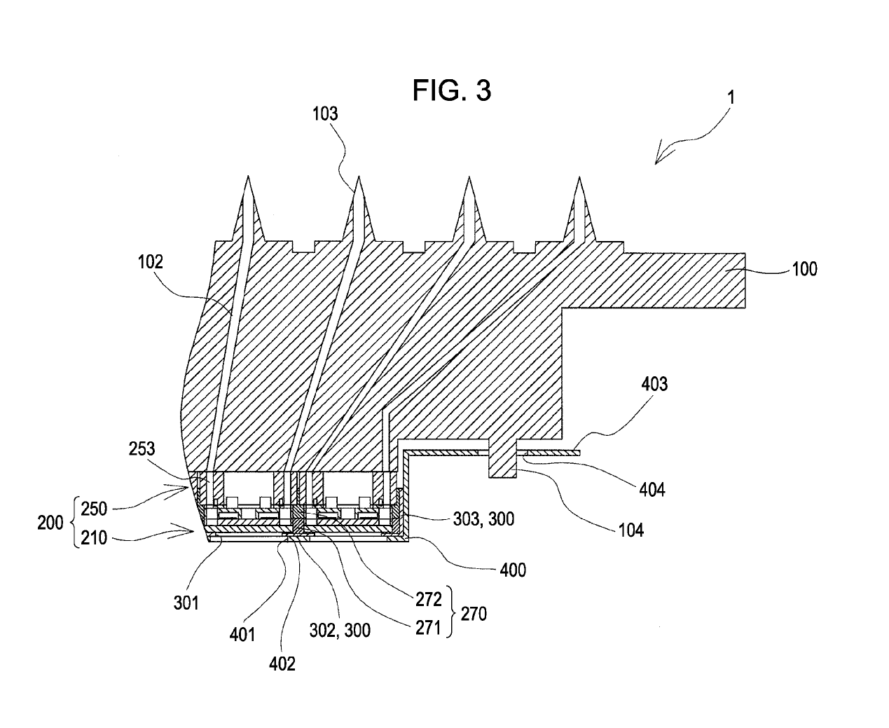

FIG. 1 is an exploded perspective view of an ink jet recording head according to a first embodiment of the invention. FIG. 2 is an assembled perspective view of the ink jet recording head. FIG. 3 is a cross-sectional view of the main portions of the ink jet recording head.

The ink jet recording head 1 (hereinafter, referred to as a “recording head”) includes a cartridge casing 100, head members 200, a fixed plate 300 and a cover head 400. The plurality of head members 200 are positioned on the fixed plate. The cartridge casing 100 may be comprised of a resin material and has cartridge mounting portions 101 in which ink cartridges (not shown) are mounted in order to serve as ink supplying units to the recording head 1. A plurality of ink communication paths 102 are formed in the bottom of the cartridge casing 100, each with one end opened to the cartridge mounting portions 101 and another end opened to the head members 200. Ink supplying needles 103 are inserted and fixed in the opened portions of the ink communication paths 102.

The plurality of head members 200, four in this example, are positioned and fixed at predetermined intervals on the bottom of the cartridge casing 100 so as to configure the recording head 1. The head members 200 of the recording head 1 correspond with a plurality of various color inks. The head members 200 are adhered to the fixed plate 300 so as to be positioned relative to each other. The head members 200 are fixed to the bottom of the cartridge casing 100 in the positioned state.

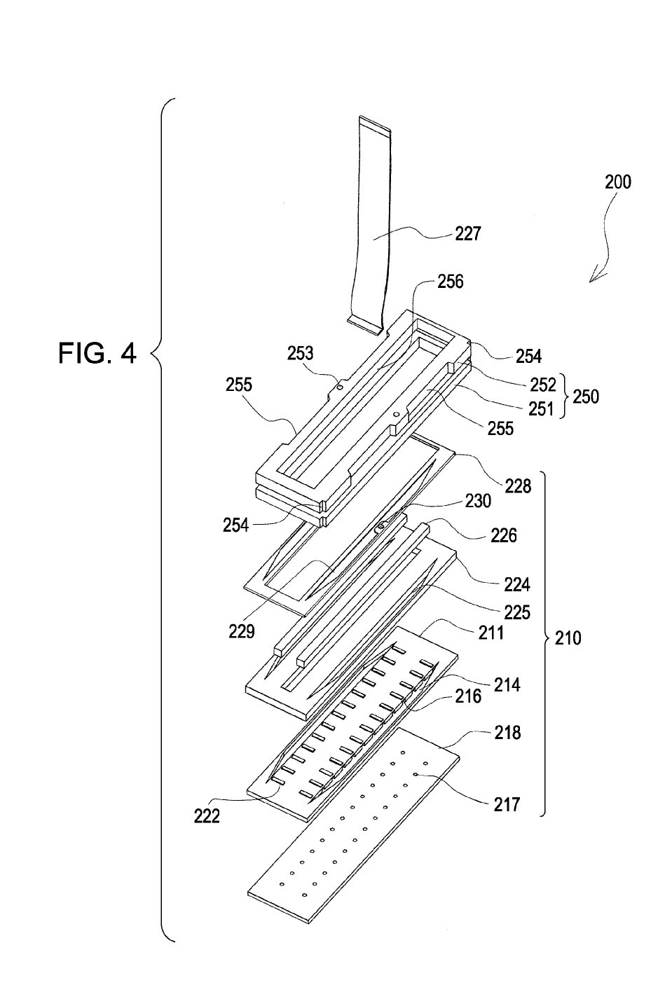

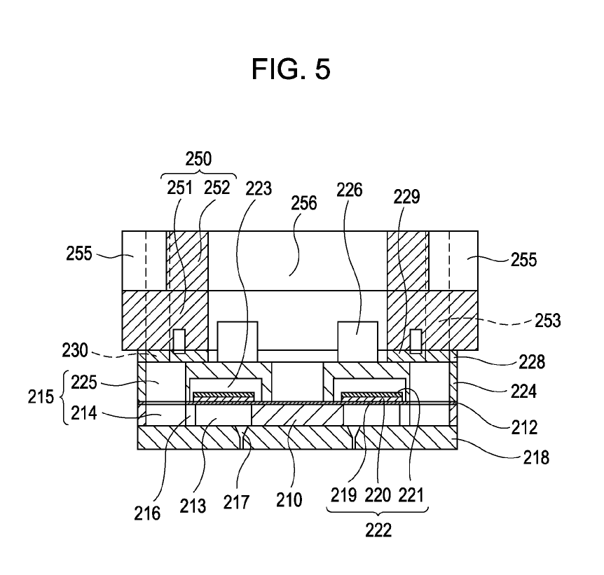

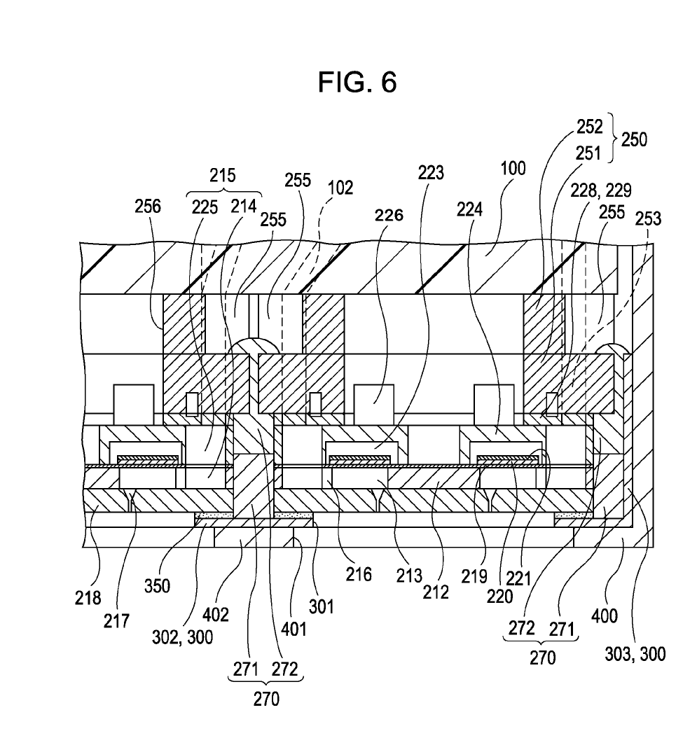

Now, the configuration of the head members 200 will be described. FIG. 4 is an exploded perspective view of the head member, FIG. 5 is a cross-sectional view of the head member, and FIG. 6 is a cross-sectional view of the main portions of the recording head. As shown in FIGS. 4 to 6, the head member 200 includes a head body 210 and a head casing 250. The channel forming substrate 211 of the head body 210 is, for example, formed of a silicon single crystal substrate. In one embodiment, an elastic film 212 (shown in FIG. 5) formed of silicon dioxide is formed on one surface of the channel forming substrate 211 by a thermal oxidation process. In the channel forming substrate 211, a plurality of pressure generating chambers 213 are formed by anisotropic etching the other surface of the channel forming substrate 211 in a predetermined pattern. In this example, the pressure generating chambers 213 are formed in with two pressure generating chambers 213 in each row of pressure generating chambers 213 formed in the width direction. In addition to the pressure generating chambers 213, a communication portion 214 is formed at the outside of pressure generating chambers 213 along the length of the channel forming substrate 211. The communication portion 214 communicates with a reservoir portion 225 provided on a protective substrate so as to configure a reservoir 215 which acts a common ink chamber of the pressure generating chambers 213. The communication portion 214 communicates with one end of the pressure generating chambers 213 through ink supplying paths 216.

A nozzle plate 218, in which a plurality of nozzles 217 capable of ejecting ink droplets are formed, is adhered to an open surface of the channel forming substrate 211 by an adhesive or hot welded film. That is, in the configuration of the head member 200 according to the present embodiment, the surface of the nozzle plate 218 becomes an ink ejecting surface. The nozzle plate 218 is comprised of, for example, stainless steel (SUS) or the like.

Meanwhile, piezoelectric elements 222 including a lower electrode film 219 formed of a metal material such as platinum or iridium, a piezoelectric layer 220 formed of lead zirconate titanate (PZT), and an upper electrode film 221 formed of a metal material such as iridium, are formed on the elastic film 212 formed on the surface of the channel forming substrate 211.

More specifically, the piezoelectric elements 222 are formed on the forming substrate 211 in an area facing the protective substrate 224, in order to form has a piezoelectric element holding portion 223 for protecting the piezoelectric elements 222. As described above, the protective substrate 224 also includes the reservoir portion 225 configuring the reservoir 215 which communicates with the communication portion 214 of the channel forming substrate 211.

A driving IC 226 for driving the piezoelectric elements 222 is mounted on the protective substrate 224. Although not shown, the terminals of the driving IC 226 are connected to lead electrodes led from separate electrodes of the piezoelectric elements 222 through bonding wires. An external wire 227 such as a flexible printed cable (FPC) is connected to the terminals of the driving IC 226 as shown in FIG. 1, so that various types of signals, such as a printing signals and the like may be supplied to the terminals of the driving IC through the external wire 227.

A compliance substrate 228 comprised of, for example, stainless (SUS) is formed and adhered to the protective substrate 224 in an area corresponding to the reservoir 215. A flexible portion 229 having a relatively small thickness is provided in an area on the compliance substrate 228 in an area corresponding to the reservoir 215, such that pressure variations in the reservoir 215 are absorbed by the deformation of the flexible portion 229. An ink introducing port 230 is formed in the compliance substrate 228 so as to communicate with the reservoir 215.

In the present embodiment, the head casing 250 is adhered to the surface of the head body 210 by adhering to the top surface of the compliance substrate 228 and the side surfaces of the channel forming substrate 211 and compliance substrate 228. Thus, the head member 200 includes the head casing 250 and the head body 210 adhered to the lower surface of the head casing 250. In the present embodiment, the head casing 250 includes a first head casing 251 adhered to the head body 210 and a second head casing 252 adhered to the upper surface (the surface opposite to the ink ejecting surface) of the first head casing 251. A plurality of ink supplying communication paths 253 are formed in the head casing 250 which communicate with the ink introducing port 230 of the compliance substrate 228 and the ink communication path 102 of the cartridge casing 100. Thus, the ink is supplied to the reservoir 215 through the ink communication path 102, the ink supplying communication paths 253, and the ink introducing port 230.

First and second notch portions 254 and 255, described more fully below, are formed in edges of the head casing 250.

A driving IC holding portion 256 penetrates through the head casing 250 in an area near the driving IC 226, and, although not shown, a potting agent is filled in the driving IC holding portion 256 so as to cover the driving IC 226. In addition, the material of the head casing 250 is not specially limited, but, in the present embodiment comprises stainless steel (SUS).

In the head member 200 having the above-described configuration, the ink is filled from the reservoir 215 to the nozzles 217. A voltage is applied to the piezoelectric elements 222 corresponding to the pressure generating chambers 213 in response to a recording signal received from the driving IC 226. The voltage causes the elastic film 212 and the piezoelectric elements 222 to curve and deform, causing a pressure to be applied to the inks in the pressure generating chambers 213, thereby ejecting the ink droplets from the nozzles 217.

The plurality of head members 200 are adhered to the fixed plate 300 so as to be positioned relative to each other at predetermined intervals. As shown in FIG. 6, openings 301 in the fixed plate 300 are provided in the head member 200 in order to expose the nozzles 217. More specifically, a beam 302 is provided in the fixed plate 300 in an area corresponding to the space between the head members 200 in order to guide the positions of the head members 200 so that the openings 301 between the head members 200 are formed at the predetermined intervals. The edges of the surfaces of the ink ejecting surface side of the head members 200, for example, the edges of the nozzle plate 218 side, are adhered by an adhesive 350 to the fixed plate 300.

Bending portions 303 are provided in the edges of the fixed plate 300 and are bent toward the head members 200. That is, the fixed plate 300 according to the present embodiment is formed in a box-like shape in which one surface is opened and has a recessed portion 304 having the bending portion 303 as sidewalls (as shown in FIG. 1), and the nozzle plate 218 of the head members 200 is adhered and fixed to the bottom of the recessed portion 304 of the fixed plate 300. The material of the fixed plate 300 is not specially limited, but a material having a linear thermal expansion coefficient that is equal to or less than that of the portions of the head members 200 adhered to the fixed plate 300, such as the nozzle plate 218, is preferably used. For example, in the present embodiment, the fixed plate 300 is comprised of stainless steel (SUS) which is the same material as used to form the nozzle plate 218.

The cover head 400 for protecting the plurality of head members 200 from ink or contaminants is provided at the periphery of the plurality of head members 200 and fixed plate 300. In the present embodiment, the cover head 400 has a plurality of exposure openings 401 for exposing the head members 200. Alternatively, one exposure opening for exposing the plurality of head members 200 may be used.

In the present embodiment, the cover head 400 is fixed to the cartridge casing 100 fixed to the head members 200. In more detail, as shown in FIGS. 2 and 3, the cover head 400 has a flange portion 403 formed on each side of the head members 200 with a fixed hole 404 penetrating through the flange portion 403. Meanwhile, in the surface of the cartridge casing 100 on the sides of the head members 200 is a protrusion 104, which is provided at a position corresponding to the fixed hole 404 of the cover head 400. The protrusion 104 of the cartridge casing 100 is inserted into the fixed hole 404 of the cover head 400 and the front end of the protrusion 104 is caulked by heating such that the cover head 400 is fixed to the cartridge casing 100.

Here, a filling portion 270 obtained by filling and curing a predetermined adhesive in the gaps between the head members 200. In the present embodiment, the filling portion 270 is continuously provided in the edges of the fixed plate 300. That is, the filling portion 270 is continuously provided in the gaps between the head members 200 and the bending portions 303 of the fixed plate 300.

In the present embodiment, the filling portion 270 includes a first filling layer 271 provided at the side of the fixed plate 300 and a second filling layer 272 provided on the first filling layer 271. A second adhesive configuring the second filling layer 272 is a material having a viscosity higher than that of a first adhesive of the first filling layer 271 in an uncured state.

The first filling layer 271 fixes the head members 200 and the fixed plate 300. Accordingly, a material having a relatively low viscosity in an uncured state is used as the first adhesive configuring the first filling layer 271 such that the first adhesive may adequately fill the gaps between the head members 200. Meanwhile, the second filling layer 272 is an adhesive having a viscosity higher than that of the first adhesive in an uncured state. Since the adhesive having the low viscosity in the uncured state has a high shrinkage rate upon curing, if the adhesive having the relatively low viscosity is used as the second adhesive, the fixed plate 300 may deform upon curing. In this embodiment, however, since the adhesive having the higher viscosity is used as the second adhesive, the deformation of the fixed plate 300 due to the shrinkage of the adhesive upon curing, and thus the curvature of the nozzle surface, may be suppressed.

If the thickness of the first filling layer 271 is too large, the fixed plate 300 may become deformed due to the shrinkage of the first adhesive upon curing. Accordingly, it is preferable that the thickness of the first filling layer 271 is as small as possible so that the fixed plate 300 and the head members 200 reliably fixed without deforming the fixed plate 300 during curing. Thus, in the preferred embodiment, the thickness of the first filling layer 271 is smaller than at least the thickness of the second filling layer 272. In particular, it is preferable that the first filling layer 271 is formed with a thickness so as to disallow the first filling layer from contacting the head casing 250. Moreover, in a preferred embodiment, the first filling layer 271 formed with a thickness to disallow the first filling layer from contacting the compliance substrate 228 or the head casing 250. This is because the head casing 250 and the compliance substrate 228 are formed of a material (stainless steel, in the preferred embodiment) which is more susceptible to deformation than the channel forming substrate 211, which is typically comprised of a silicon substrate. Accordingly, if both the head casing and the compliance substrate are in contact with the first filling layer 271, the head casing 250 may be deformed due to the shrinkage of the adhesive upon curing and thus the fixed plate 300 is susceptible to deformation.

By using the filling portion 270 of the present invention, it is possible to reliably fix the fixed plate 300 and the head members 200 using the first filling layer 271. Moreover, since the gaps between the head members 200 are adequately filled by the filling portion 270, it is possible to maintain excellent printing quality. That is, if a mist of ink droplets ejected from the nozzles 217 intrudes into and deposits in the gaps between the head members 200, the ink may be adhered to the recording medium. By providing the filling portion 270, the mist of ink droplets is able to accumulate in the gaps between the head members 200. Thus, it is possible to prevent the recording medium from being contaminated and always maintain excellent printing quality.

The filling portion 270 is formed by positioning and fixing the head members 200 to the fixed plate 300 and filling and curing the predetermined adhesives in the gaps between the head members 200. In the present embodiment, the first adhesive is filled in the gaps between the head members 200 and is cured so as to form the first filling layer 271. Thereafter, the second adhesive is filled in the gaps between the head members 200 and is cured so as to form the second filling layer 272. Accordingly, the filling portion 270 is formed from the first and second filling layers 271 and 272.

In some instances, the filling portion 270 of the first and second adhesives may be introduced from the head casing 250 of the head members 200 via the gaps between the head members 200. Since the gaps between the head members 200 are narrow, however, filling of the first and second adhesives in the gaps is difficult and time-consuming. Moreover, the first and second adhesives may adhere to the surface of the head casing 250 during the filling process and cause a subsequent adhesion failure when the head casing 250 and the cartridge casing 100 are adhered. However, in the recording head 1 according to the invention, as described below, the first and second adhesives can be more easily filled in the gaps between the head members 200 and the filling portion 270.

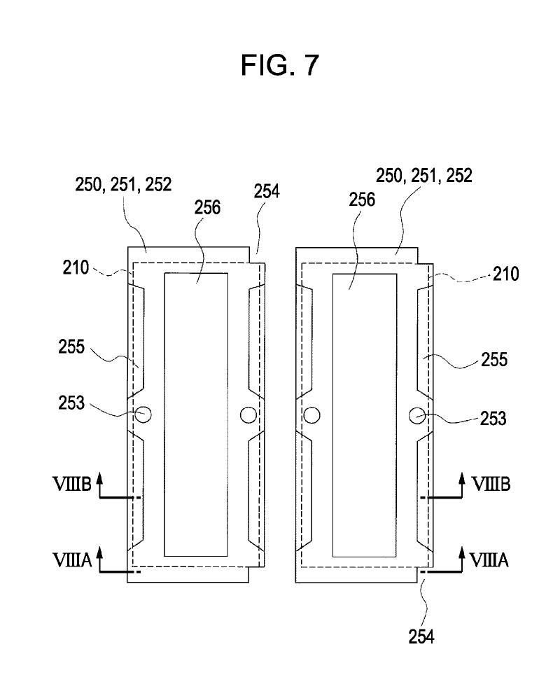

FIG. 7 is a plan view of the head casing 250. As shown in FIGS. 5 to 7, a plurality of first notch portions 254 into which the first adhesive is introduced and second notch portions 255 into which the second adhesive is introduced are formed in the head casing 250. In the preferred embodiment, the opening area of the plurality of second notch portions has an opening area larger that of the first notch portions 254. In the present embodiment, the first notch portions 254 are provided at two corners of one side of the head casing 250 of the head members 200. The second notch portions 255 are provided in both sides of the head casing 250 on the sides of the ink supplying communication paths 253. The opening area described herein indicates the opening areas of the first and second notch portions 254 and 255 in the surface of the head casing 250 shown in FIG. 7.

The first notch portions 254 extend through the head casing 250 in the thickness direction, while the second notch portions 255 are formed without penetrating through the head casing 250 in the thickness direction. Moreover, in the present embodiment, as described above, the head casing 250 includes first and second head casing 251 and 252. The first notch portions 254 are provided in both the first and second head casings 251 and 252, while the second notch portions 255 are formed in only the second head casing 252. The head casing 250 according to the present embodiment is slightly larger than the head body 210 and the head body 210 is adhered to the central portion of the lower surface of the head casing 250. The first notch portions 254 are formed in an area in which the head body 210 is not adhered to the head casing 250.

In the head casing 250 of the above-described configuration, when the head body 210 is adhered to the lower surface of the head casing 250, the entire adhesion surface of the head body 210 is brought into contact with the lower surface of the head casing 250. Accordingly, since the entire adhesion surface of the head body 210 is uniformly pressurized by the head casing 250, both the head body and the head casing may be appropriately adhered.

In addition, since the second notch portions 255 are formed without reaching the lower surface of the head casing 250, although the second notch portions 255 do not extend to the to the area surrounding the head body 210 like the first notch portions 254, the entire adhesion surface of the head body 210 can be brought into contact with the lower surface of the head casing 250. Accordingly, the second notch portions 255 may be formed so as to extend to a portion of the head casing above the area in which the head body 210 is adhered. That is, the area in which the second notch portions 255 are formed is not restricted. Accordingly, it is possible to miniaturize the head casing 250.

If the second notch portions extend through the entire head casing, the second notch portions need to be formed at a portion of the head casing that extends beyond the adhesion area between the head casing and the head body. That is, the head casing needs to be enlarged. However, in the configuration of the present invention, since the formation positions of the second notch portions are not restricted, it is possible to appropriately adhere the head casing and the head body while miniaturizing the head casing.

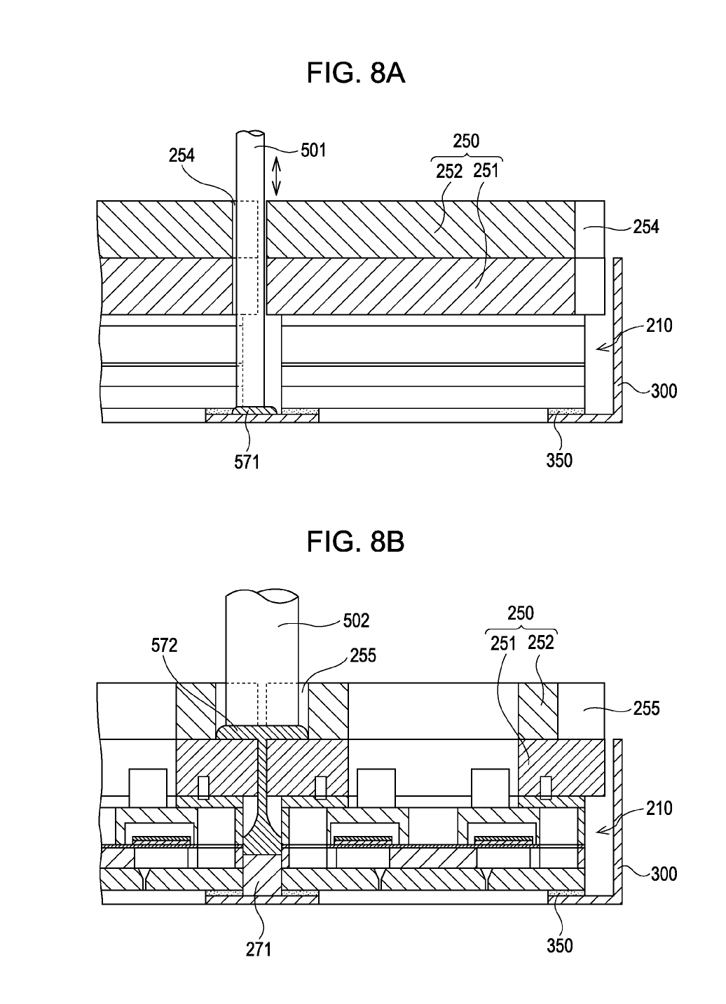

FIG. 8 is a view showing a process of forming the filling portion, wherein FIG. 8A is a cross-sectional view taken along line VIIIA-VIIIA of FIG. 7 and FIG. 8B is a cross-sectional view taken along line VIIIB-VIIIB of FIG. 7. As shown in FIG. 8A, when the plurality of head members 200 are positioned and fixed to the fixed plate 300, first syringes 501 are inserted into the first notch portions 254 and the first adhesive 571 is introduced from the first syringes 501 into the gaps between the head members 200. In the present embodiment, the first notch portions 254 extend into an area next to the head body 210 where the head casing 250 is not adhered to the head body 210. Accordingly, the first syringes 501 can be inserted into the first notch portions 254 up to the area of the fixed plate 300. By flowing the first adhesive 571 from the front end of the first syringes 501 into the gaps between the head members 200, the first adhesive 571 can be spread so as to fill the entire gaps between the head members 200 in a relatively short time. The first adhesive 571 is then cured to form the first filling layer 271. Consequently, the head body 210 and the fixed plate 300 are reliably fixed together by the first filling layer 271.

Next, as shown in FIG. 8B, second syringes 502 are inserted into the second notch portions 255 provided independent of the first notch portions 254 and the second adhesive 572 is introduced from the second syringes 502 into the gaps between the head bodies 210. At this time, since the first notch portions 254 and the second notch portions 255 are separately provided, the second adhesive 572 can flow into the gaps between the head members 200. Since the first notch portions 254 and the second notch portions 255 are separately provided, the first adhesive 571 does not accumulate in the second notch portions 255, meaning that the second adhesive 572 is not prevented from filling the gaps.

A material having a viscosity higher than that of the first adhesive in the uncured state is used as the second adhesive. Accordingly, it is preferable that the inner diameter of the second syringes 502 is larger than that of the first syringes 501. Since the opening area of the second notch portions 255 is larger than that of the first notch portions 254, the inner diameter of the second syringes 502 may be relatively large. Accordingly, although the second adhesive 572 has a relatively high viscosity, the second adhesive can appropriately flow into the gaps by the second syringes 502. If the viscosity of the second adhesive is high, it may take a large amount of time to fill the gaps between the head members 200 with the second adhesive via the second notch portions 255 using standard sized syringes and operation efficiency may deteriorate. However, in the configuration of the present embodiment, a predetermined amount of second adhesive may be introduced into the second notch portions 255 by the second syringes 502. That is, if the predetermined amount of second adhesive is distributed into the second notch portions 255, the second adhesive in the second notch portions 255 will gradually filled in the gap between the head members 200. Accordingly, since the operation for introducing the second adhesive by the second syringes 502 is quicker, the operation efficiency does not deteriorate. Moreover, when the second adhesive is introduced into the second notch portions 255, the second adhesive does not adhered to the surface of the head casing 250 and, in the subsequent processes, the head casing (head member) 250 and the cartridge casing 100 may still be appropriately adhered.

Since the second adhesive filled in the gaps between the head members 200 is cured, the filling portion 270 including the first and second filling layers 271 and 272 can be efficiently and quickly formed.

The sizes (opening areas) of the first and second notch portions 254 and 255 are not specially limited and may be appropriately determined in consideration of the thickness of the first or second syringes 501 or 502. It is preferable that the second notch portions 255 are formed as large as possible. Accordingly, even when a relatively large amount of second adhesive is filled in the gaps between the head members 200, the operation can be quickly finished and thus operation efficiency can be improved.

As the second adhesive configuring the second filling layer 272, an adhesive having a viscosity higher than that of the first adhesive in the uncured state is used, but a material having a relatively low hardness in a cured state is even more preferably used. Using such a material, it is possible to suppress the shrinkage of the adhesive upon curing with more certainty and suppress the deformation of the fixed plate 300 due to the shrinkage of the adhesive upon curing.

### Other Embodiments

Although the invention is described with reference to the previously described embodiment, the invention is not limited to the above-described configuration. For example, although in the above-described embodiment, the first and second notch portions are separately provided, the invention is not limited thereto. The first and second notch portions may be provided at the same position of the head casing. Similarly, in the above-described embodiment, the head casing is larger than the head body and the first and second notch portions are provided in only the head casing. However, for example, the head casing and the head body may have the same size. In this case, it is preferable that at least the first notch portions are continuously formed so as to extend through both the head casing and the head body. That is, it is preferable that the first notch portions are formed such that the first syringes for introducing the first adhesive can be inserted up to the surface of the fixed plate.

Although the head casing includes a lamination of two members such as the first and second head casings, the head casing may include a lamination of at least three members. In addition, the head casing may be comprised of a plurality of members which are not laminated.

Although, in the above-described embodiment, the filling portion is provided in the vicinities of the head members and, more particularly, in the gaps between the head members and between the head members and the bending portion, the invention is not limited thereto. That is, the filling portion may be provided in at least the gaps between the head members.

In addition, although, a bending vibration type piezoelectric element is used as a pressure generating element in the above-described embodiment for applying pressure to the liquid in the pressure generating chamber, the pressure generating element is not specially limited. For example, a longitudinal vibration type piezoelectric element which expands/shrinks in an axial direction by alternately laminating a piezoelectric material and an electrode forming material or a heating element may be used.

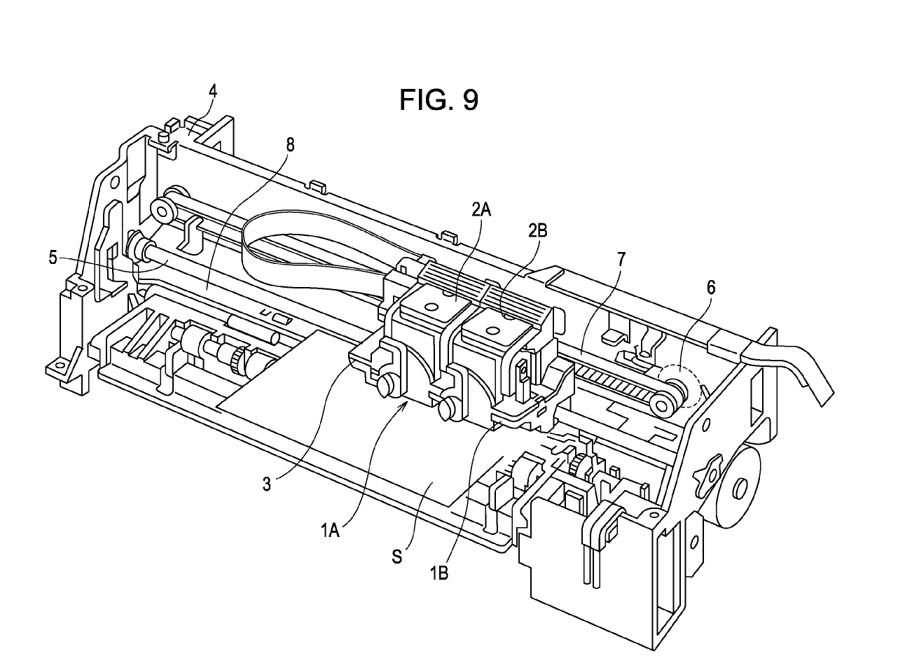

The above-described recording head 1 comprises a recording head unit which includes an ink channel which communicates with the ink cartridge which is mounted in an ink jet recording apparatus. FIG. 9 is a schematic view of an example of an ink jet recording apparatus including the recording head 1 of the present invention.

As shown in FIG. 9, in recording heads 1A and 1B, cartridges 2A and 2B configuring the ink supplying unit are detachably provided and a carriage 3 in which the recording heads 1A and 1B are movably provided in an axial direction on a carriage shaft 5 attached to an apparatus device body 4. These recording heads 1A and 1B are, for example, ones which eject a black and color ink compositions, respectively. A drive force from a drive motor 6 is transmitted to the carriage 3 via a plurality of gears (not shown) and a timing belt 7. Thus, the carriage 3 having the recording heads 1A and 1B mounted thereon is moved along the carriage shaft 5. Meanwhile, a platen 8 is provided along the carriage shaft 5 in the apparatus body 4, and a recording sheet S, or other recording medium, such as paper, is fed by a feed roller (not shown) or the like and carried on the platen 8.

Moreover, although the above-described embodiment is an ink jet recording head for ejecting ink droplets, the invention is applicable to a variety of liquid ejecting heads currently known in the art. The liquid ejecting head may, for example, include various kinds of recording heads used in an image recording apparatuses such as printers, coloring material ejecting heads used for manufacturing color filters for liquid crystal displays and the like, electrode material ejecting heads used for forming electrodes for organic EL displays, field emission displays (FED) and the like, and bio-organic matter ejecting heads used for manufacturing biochips, and the like.

What is claimed is:

1. A liquid ejecting head comprising:
a head body capable of ejecting a liquid in a pressure generating chamber through a plurality of nozzles from a liquid ejecting surface by pressurizing the pressure generating chamber;
a plurality of head members having a liquid pressure generating chamber and a head casing with a channel capable of supplying the liquid to the pressure generating chamber, the head casing having a plurality of first and second notch portions, wherein the first notch portions extend through the head casing and to reach a lower surface of the head casing, while the second notch portions extend through a portion of the head casing without reaching the lower surface of the head casing;
a fixed member adhered to a liquid ejecting surface of the head members on which the plurality of head members are positioned at predetermined intervals with a plurality of gaps being formed between the head members; and
a filing portion filled in the plurality of gaps between the head members and cured, the filing portion comprising a predetermined adhesive including a first filling layer comprising a first adhesive provided on the fixed member and a second filling layer provided on the first filling layer which is comprised of a second adhesive having a viscosity higher than that of a first adhesive in an uncured state;
wherein the first adhesive is introduced into the gap between the head members via the first notch portions of the head casing and the second adhesive is introduced into the gap between the head members via the second notch portions of the head casing.

2. The liquid ejecting head according to claim 1, wherein the first notch portions and the second notch portions are separately provided in the head casing.

3. The liquid ejecting head according to claim 1, wherein the head casing includes a first head casing adhered to the head body and a second head casing adhered onto the first head casing, wherein the second notch portions are formed in the second head casing and not in the first head casing.

4. The liquid ejecting head according to claim 1, wherein an opening area of the second notch portions is larger than the opening area of the first notch portions.

5. The liquid ejecting head according to claim 1, wherein the area of the surface of the head casing adhered to the head body is larger than the surface of the head body adhered to the head casing, such that the edges of the head casing extend beyond the edge of the head body.

6. The liquid ejecting head according to claim 5, wherein the first and second notch portions are provided in a portion of the head casing that extends beyond the head body.

7. The liquid ejecting head according to claim 1, wherein the thickness of the first filling layer is smaller than that of the second filling layer.

8. The liquid ejecting head according to claim 1, wherein the first charging layer is formed with a thickness so as to prevent the first filling layer from being in contact with the head casing.

9. A liquid ejecting apparatus comprising the liquid ejecting head according to claim 1.

10. A liquid ejecting head comprising:
a head body capable of ejecting a liquid in a pressure generating chamber through a plurality of nozzles from a liquid ejecting surface by pressurizing the pressure generating chamber;
a plurality of head members having a liquid pressure generating chamber and a head casing with a channel capable of supplying the liquid to the pressure generating chamber, a first head casing having a plurality of separately formed first notch portions, and a second head casing being adhered to the first head casing and having second and third notch portions, the second notch portions corresponding to the first notch portions of the first head casing, the second notch portions having an opening area that is larger than the opening area of the first and third notch portions;
a fixed member adhered to a liquid ejecting surface of the head members on which the plurality of head members are positioned at predetermined intervals with a plurality of gaps being formed between the head members; and
a filing portion filled in the plurality of gaps between the head members and cured, the filing portion comprising a first filling layer comprising a first adhesive provided on the fixed member and a second filling layer provided on the first filling layer which is comprised of a second adhesive having a viscosity higher than that of a first adhesive in an uncured state, the second filling layer being thicker than the first filling layer;
wherein the first adhesive is introduced into the gap between the head members via the second and third notch portions of the first and second head casing, respectively, and the second adhesive is introduced into the gap between the head members via the first notch portions of the second head casing, the first filling layer being sufficiently thin so that the first filling layer does not come into contact with the head casing.

11. The liquid ejecting head according to claim 10, wherein the area of the surface of the first head casing adhered to the head body is larger than the surface of the head body adhered to the first head casing, such that the edges of the first head casing extend beyond the edge of the head body.

12. A liquid ejecting apparatus comprising the liquid ejecting head according to claim 10.
